(19) United States
(12) Patent Application Publication
(10) Pub. No.: US 2005/0107900 A1
(43) Pub. Date: May 19, 2005

(54) Portable computer adapted for use with a loudspeaker unit to reproduce audio playback information with surround sound effects

(76) Inventors: Wei-sheng Tseng, Taipei Hsien (TW); Wen-chen Tang, Taipei Hsien (TW)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 10/829,710

(22) Filed: Apr. 22, 2004

(30) Foreign Application Priority Data
Nov. 14, 2003 (TW) 092220240

(51) Int. Cl. G06F 17/00; H04R 5/00

(52) U.S. Cl. 700/94; 381/77

(57) ABSTRACT

A portable computer includes a main board mounted in a computer housing for receiving audio playback information from an audio source, an audio processing module mounted on the main board for transforming the audio playback information therefrom into audio signals in a set of channels, and a coupling interface mounted on the computer housing and connected electrically to the audio processing module. The coupling interface includes first and second input ports, and an output port, each of which is configured for transmitting the audio signals in two corresponding ones of the channels and is adapted to be connected electrically to at most two of loudspeakers of a loudspeaker unit such that each of the loudspeakers is able to reproduce the audio signal in a respective one of the channels with a respective one of the sound effects.

### CROSS-REFERENCE TO RELATED APPLICATION

This application claims priority of Taiwanese Application No. 092220240, filed on Nov. 14, 2003.

### BACKGROUND OF THE INVENTION

1. Field of the Invention

The invention relates to a portable computer, more particularly to a portable computer adapted for use with a loudspeaker unit to reproduce audio playback information with surround sound effects.

2. Description of the Related Art

At present, audio playback techniques for a computer device have progressed to an extent where audio playback information from a DVD file can be reproduced with 5.1-channel sound effects.

Referring to FIG. 1, a conventional portable computer 9 includes an audio processing unit 914, a line output port 911, a microphone input port 912 and a line input port 913. In a normal mode for reproducing audio playback information, the audio processing unit 914 transforms the audio playback information into audio signals in left and right channels such that two loudspeakers 81, 82, which are coupled to the line output port 911, are able to reproduce the audio signals in the left and right channels with left-channel and right-channel sound effects, respectively. In a 5.1-channel mode for reproducing audio playback information, the audio processing unit 914 transforms the audio playback information into AC3 signals outputted via an S/PDIF (SONY/PHILIPS Digital Interface) interface. It is noted that the AC3 signals should be decoded by an additional decoder 7, which is externally coupled to the S/PDIF interface. Therefore, the conventional portable computer 9, together with the decoder 7, can be used with a loudspeaker unit (not shown) coupled to the decoder 7 for reproducing the audio playback information with surround sound effects.

However, the decoder 7 is an expensive device, thereby resulting in relatively high implementation costs.

### SUMMARY OF THE INVENTION

Therefore, the object of the present invention is to provide a portable computer adapted for use with a loudspeaker unit to reproduce audio playback information having surround effects and without requiring an additional decoding device.

According to the present invention, there is provided a portable computer adapted for use with a loudspeaker unit to reproduce audio playback information with a set of different sound effects. The loudspeaker unit includes a set of loudspeakers. The portable computer comprises:
a computer housing;
a main board mounted in the computer housing for receiving the audio playback information from an audio source;
an audio processing module mounted on the main board for transforming the audio playback information therefrom into audio signals in a set of channels; and
a coupling interface mounted on the computer housing, connected electrically to the audio processing module, and including first and second input ports, and an output port, each of which is configured for transmitting the audio signals in two corresponding ones of the channels and is adapted to be connected electrically to at most two of the loudspeakers of the loudspeaker unit such that each of the loudspeakers is able to reproduce the audio signal in a respective one of the channels with a respective one of the sound effects.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram showing a conventional portable computer together with a decoder for surround sound reproduction;

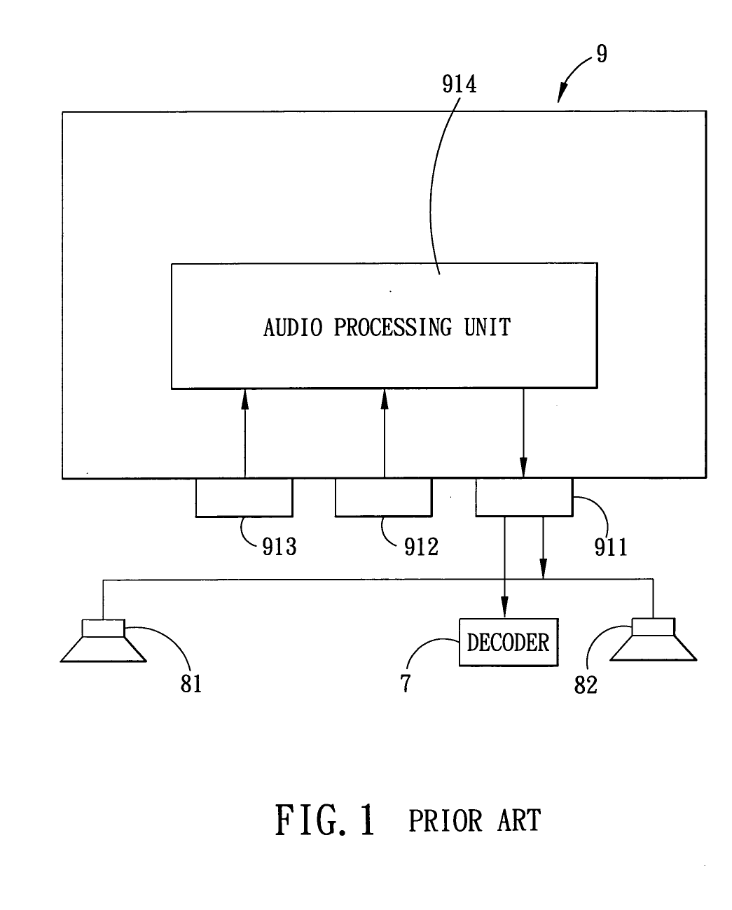

FIG. 2 is a schematic diagram showing the preferred embodiment of a portable computer according to the present invention; and

FIG. 3 is a schematic circuit block diagram showing the preferred embodiment.

### DETAILED DESCRIPTION OF THE PREFERRED EMBODIMENT

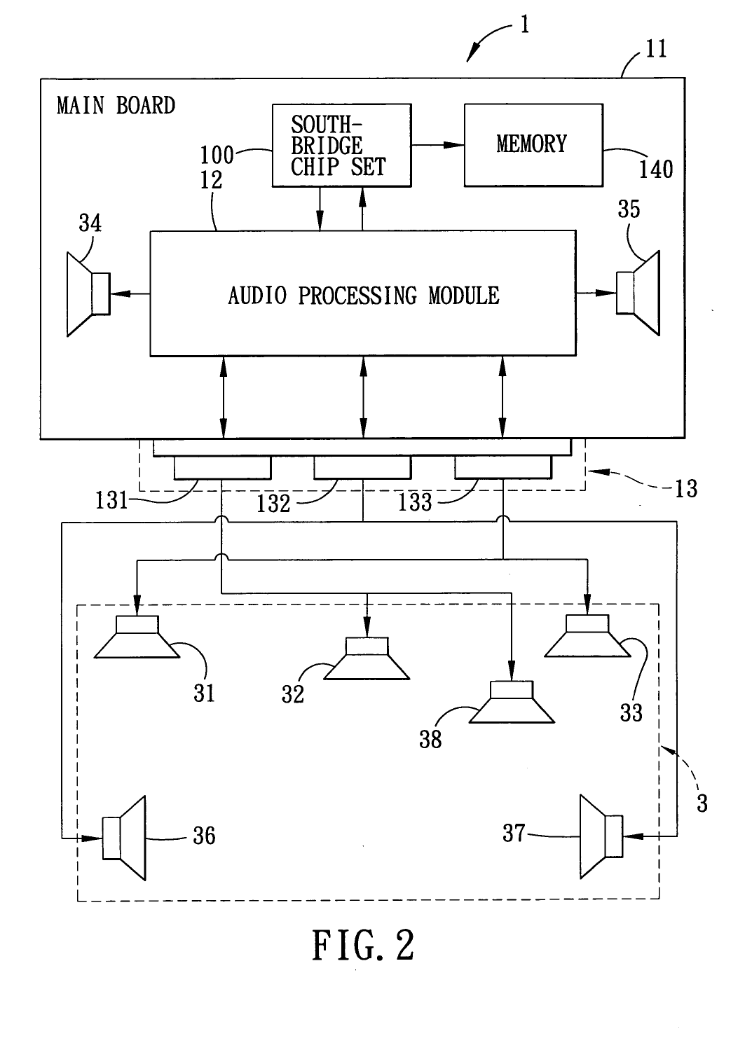

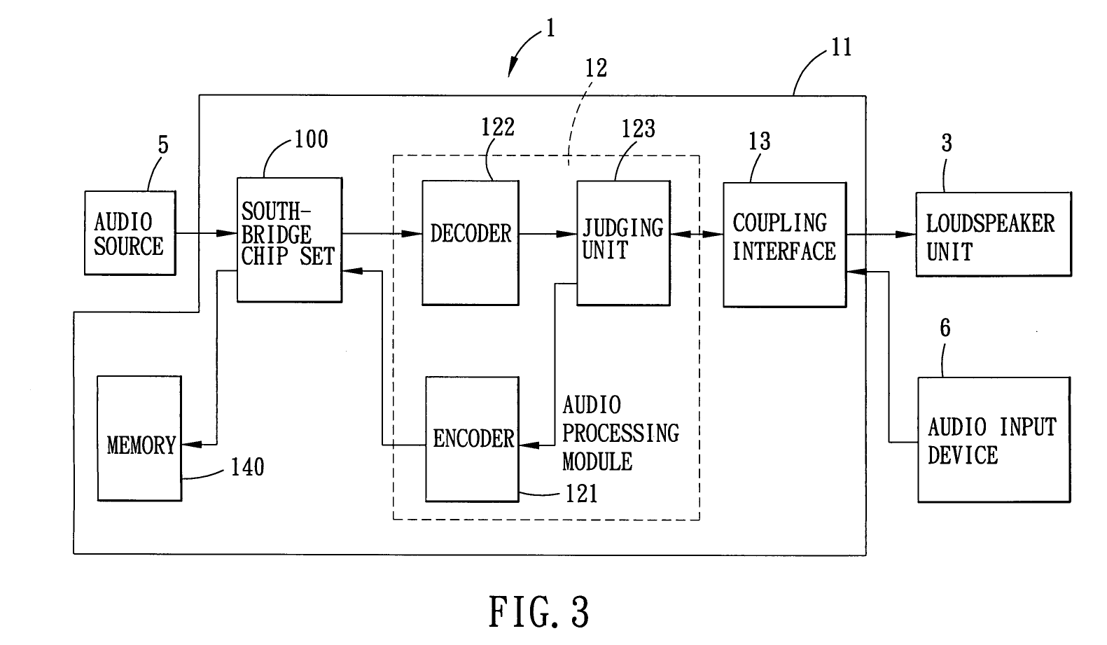

Referring to FIGS. 2 and 3, the preferred embodiment of a portable computer 1, such as a notebook computer, according to the present invention is shown to be adapted for use with a loudspeaker unit 3 to reproduce audio playback information with a set of different surround effects. The loudspeaker unit 3 includes a set of loudspeakers 31, 32, 33, 36, 37, 38. The portable computer 1 includes a computer housing (not shown), a main board 11, an audio processing module 12, and a coupling interface 13.

The main board 11 is mounted in the computer housing, and receives the audio playback information from an audio source 5, such as a DVD file or multimedia data with the surround effects of front left and right channels, left and right channels, surround left and right channels, a center channel and a subwoofer channel. In this embodiment, the main board 11 includes a south-bridge chip set 100 adapted to be coupled to the audio source 5 for receiving the audio playback information therefrom.

The audio processing module 12 is mounted on the main board 11 and is connected electrically to the south-bridge chip set 100 for transforming the audio playback information received from the audio source 5 into audio signals in a set of channels, such as front left and right channels, left and right channels, surround left and right channels, a center channel and a subwoofer channel. In this embodiment, the audio processing module 12 includes an AC'97 v2.3 control chip set that conforms to an AC' 97 standard set by INTEL and that has an encoder 121 and a decoder 122 for conversion between analog and digital signals. Alternatively, the AC'97 v2.3 control chip set can also be replaced by an AZALIA control chip set obtained from INTEL. As such, the audio processing module 12 can perform 6-channel effects by programmably configuring specific pins of a conventional 2-channel control chip set.

The coupling interface 13 is mounted on the computer housing, is connected electrically to the audio processing module 12, and includes first and second input ports 131, 132, and an output port 133, each of which is configured for transmitting the audio signals in two corresponding ones of the channels and is adapted to be connected electrically to at most two of the loudspeakers 31, 32, 33, 36, 37, 38 such that each of the loudspeakers 31, 32, 33, 36, 37, 38 is able to reproduce the audio signal in a respective one of the channels with a respective one of the sound effects. In this embodiment, the first input port 131 is a microphone input port, the second input port 132 is a line input port, and the output port 133 is a line output port. In addition, the portable computer 1 further includes a pair of built-in loudspeakers 34, 35 mounted in the computer housing and coupled to the audio processing module 12. Therefore, as shown in FIG. 2, the built-in loudspeakers 34, 35 respectively present sound effect in left and right channels. The loudspeakers 32, 38 coupled to the first input port (microphone input port) 131 respectively present sound effects in a center channel and a subwoofer channel. The loudspeakers 36, 37 coupled to the second input port (line input port) 132 respectively present sound effects in surround left and right channels. The loudspeakers 31, 33 coupled to the output port (line output port) 133 respectively present sound effects in front left and right channels.

On the other hand, at least one of the first and second input ports 131, 132 is adapted to be coupled to a respective audio input device 6. The audio processing module 12 further includes a judging unit 123 coupled to the encoder 121, the decoder 122 and the coupling interface 13 for judging whether the at least one of the first and second input ports 131, 132 is connected electrically to the respective audio input device 6, such as by detecting the impedance at the first and second input ports 131, 132. For example, when the respective audio input device 6 is a microphone, audio signals from the microphone are encoded by the decoder 121 and are then stored in a memory 140 mounted on the main board 140 via the south-bridge chip set 100 for subsequent processing process.

To sum up, the portable computer 1 of the present invention can be configured to perform 5.1-channel sound effects via the coupling interface 13 with the use of the audio processing module 12. Furthermore, due to the presence of the judging unit 123, the presence of the respective audio input device 6 can be judged so as to retain the original input/output function of the coupling interface 13.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A portable computer adapted for use with a loudspeaker unit to reproduce audio playback information with a set of different sound effects, the loudspeaker unit including a set of loudspeakers, said portable computer comprising:
a computer housing;
a main board mounted in said computer housing for receiving the audio playback information from an audio source;
an audio processing module mounted on said main board for transforming the audio playback information therefrom into audio signals in a set of channels; and
a coupling interface mounted on said computer housing, connected electrically to said audio processing module and including first and second input ports, and an output port, each of which is configured for transmitting the audio signals in two corresponding ones of the channels and is adapted to be connected electrically to at most two of the loudspeakers of the loudspeaker unit such that each of the loudspeakers is able to reproduce the audio signal in a respective one of the channels with a respective one of the sound effects.

2. The portable computer as claimed in claim 1, wherein said first input port is a microphone input port, said second input port is a line input port, and said output port is a line output port.

3. The portable computer as claimed in claim 1, wherein at least one of said first and second input ports is adapted to be coupled to a respective audio input device.

4. The portable computer as claimed in claim 3, wherein said audio processing module includes a judging unit coupled to said coupling interface for judging whether said at least one of said first and second input ports is connected electrically to the respective audio input device.

5. The portable computer as claimed in claim 1, wherein said audio processing module includes an AC'97 v2.3 control chip set.

6. The portable computer as claimed in claim 1, wherein said audio processing module includes an AZALIA control chip set.

7. The portable computer as claimed in claim 2, further comprising a pair of built-in loudspeakers mounted in said computer housing and coupled to said audio processing module.

8. The portable computer as claimed in claim 7, wherein said built-in loudspeakers respectively present sound effects in left and right channels, the loudspeakers coupled to said microphone input port respectively presenting sound effects in a center channel and a subwoofer channel, the loudspeakers coupled to said line input port respectively presenting sound effects in surround left and right channels, the loudspeakers coupled to said line output port respectively presenting sound effects in front left and right channels.
